(19) United States
(12) Patent Application Publication
(10) Pub. No.: US 2008/0107025 A1
(43) Pub. Date: May 8, 2008

(54) Apparatus for Detecting Data Looping Phenomenon and Method Used by the Same

(75) Inventors: Jai-Hyung Cho, Daejeon-city (KR); Sung-Back Hong, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Instit, Daejeon-city (KR)

(21) Appl. No.: 11/718,884

(22) PCT Filed: May 16, 2005
(86) PCT No.: PCT/KR05/01425

§ 371 Date: Oct. 18, 2007

(30) Foreign Application Priority Data
Nov. 10, 2004 (KR) 10-2004-0091571

(51) Int. Cl. H04L 1/00

(52) U.S. Cl. 370/235

(57) ABSTRACT

Provided is a switching device for detecting and removing a looping phenomenon in a data communication network and a method using the switching device. The method includes: detecting a frame checksum value; counting the number of times of a checksum value corresponding to the frame checksum value is received; and declaring a looping phenomenon when the number of times exceeds a predetermined threshold. The method makes it possible to easily detect a looping phenomenon using the checksum value.

### TECHNICAL FIELD

The present invention relates to an apparatus for detecting and removing a data looping phenomenon and a method used by the same, and more particularly, to a switching apparatus for detecting and removing a data looping phenomenon using a checksum value used to detect an error of a bit stream, and a method used by the same.

### BACKGROUND ART

In a data looping phenomenon, data headed for a destination terminal are repeatedly transmitted among transmission devices constituting a communication network.

FIG. 1 is a diagram of a conventional data communication network. Referring to FIG. 1, when a source terminal 140 transmits data to a destination terminal 150, data are transmitted from the source terminal 140 to a switching device 130 connected to the destination terminal 150 through switching devices 110 and 120, which constitute a communication network. Due to a routing error of the switching device 130 connected to the destination terminal 150, a phenomenon called data looping can occur, in which data are repeatedly transmitted among switching devices 110, 120, 130.

Data looping phenomena are caused by an error of a route setting algorithm of the communication network, or by a communication link being disconnected while a route is being automatically reconfigured. Examples of data communication networks where a looping phenomenon occurs are an IP network composed of an IP router, an Ethernet network composed of Ethernet switches, and an ATM network composed of ATM switches, etc., which transmit block data in a unit of a packet having a variable-length or a cell having a fixed length. A conventional method of detecting and removing a data looping phenomenon in the data communication network uses a counting unit field such as time to live (TTL) in a data packet header. The source terminal 140 inputs an initial value in the TTL field of all packets. Intermediate nodes 110, 120, and 130 for relaying a packet reduce a TTL value. When the TTL value is 0, the packet is discarded. When a looping phenomenon occurs in a transmission route of the communication network, and a data packet is repeatedly transmitted among intermediate nodes 110, 120, and 130, the TTL value of the data packet is reduced to 0 by intermediate nodes 110, 120, and 130, resulting in discarding of the looped packet.

In the method of detecting a looping phenomenon using TTL, TTL values must be indicated for all the data. However, since a standard Ethernet frame and ATM cell do not have an additional field to indicate TTL information, it is impossible to detect a looping phenomenon and correct a wrong route when the looping phenomenon occurs.

In the data communication network, a checksum used to detect an error of a bit stream of data makes a data pattern different even if a data block has a different bit.

Data blocks are transmitted along with their respective checksum values. The greater the size of a checksum field, the less the probability of having the same checksum value.

FIG. 2 is a diagram of an Ethernet frame structure. Referring to FIG. 2, the Ethernet frame comprises a destination address field 210, a source address field 220, a length/type field 230, a payload field 240, and a frame check sequence (FCS) field 250. The FCS field 250 includes checksum information.

The source terminal that generates the Ethernet frame records the checksum value that calculates the maximum frame information of 1500 bytes by summing up a header and data of the Ethernet frame in the FCS field 250. The checksum value has a total of 2³²(4, 294, 967, 296) different values according to a data change of the Ethernet frame. In an Ethernet communication network, the probability of a coincidence of the FEC value is very scarce below 10⁻¹⁰ unless a user manipulates the FCS value on purpose.

### DISCLOSURE OF INVENTION

Technical Solution

The present invention provides an apparatus for detecting a looping phenomenon and a method using the same that quickly detect a route looping phenomenon and correct the route looping using a checksum value used to detect a data error in a data communication network that does not use a conventional counting unit field such as time to live (TTL), thereby improving safety and efficiency of the data communication network.

The present invention also provides a computer readable medium having embodied thereon a computer program for executing a method of detecting a looping phenomenon that quickly detects a route looping phenomenon and corrects route looping using a checksum value used to detect a data error in a data communication network that does not use a conventional counting unit field such as time to live (TTL), thereby improving safety and efficiency of the data communication network.

Advantageous Effects

The switching device makes it possible to detect and remove data looping phenomenon without replacing the conventional communication network in a data communication network that does not use a counting unit field, i.e., time to live (TTL), such as an Ethernet network, an ATM network, a frame relay network, etc. The switching device removes a communication interruption, reduces bandwidth consumption, and reduces a congestion phenomenon caused by route looping, thereby improving stability.

### DESCRIPTION OF DRAWINGS

The above and other features and advantages of the present invention will become more apparent by describing in detail embodiments thereof with reference to the attached drawings in which:

FIG. 1 is a diagram of a conventional data communication network;

FIG. 2 is a diagram of an Ethernet frame structure;

FIG. 3A is a block diagram of a switching device for detecting a looping phenomenon according to an embodiment of the present invention;

FIG. 3B is a flow chart illustrating a method of detecting a looping phenomenon using the switching device according to an embodiment of the present invention;

FIG. 3C is a flow chart illustrating another method of detecting a looping phenomenon using the switching device according to an embodiment of the present invention; and

FIG. 4 is diagram of a checksum table used to store frame information in the switching device according to an embodiment of the present invention.

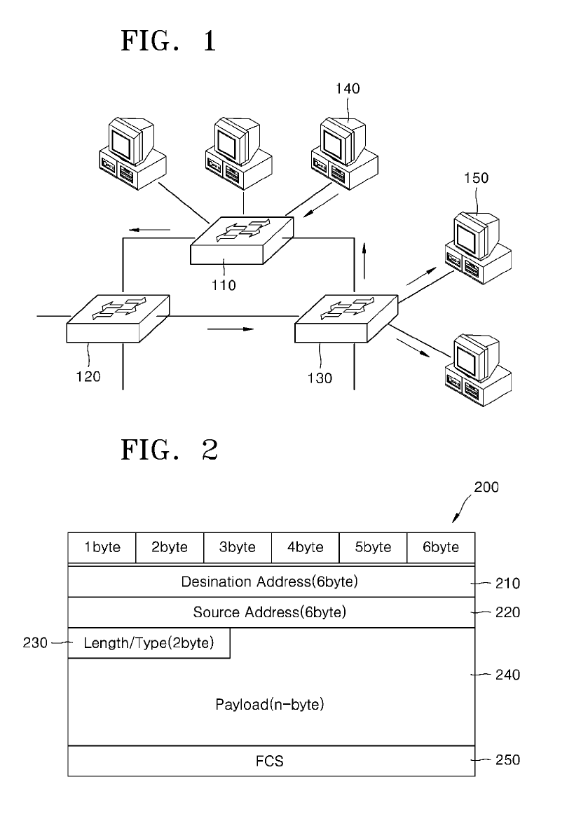

### BEST MODE

According to an aspect of the present invention, there is provided a n apparatus for detecting a looping phenomenon, comprising: a checksum detector detecting a checksum value in a frame; a counting unit counting the number of times a frame having the same checksum value as the detected checksum value is received; and a looping phenomenon determiner declaring a frame looping phenomenon when the number of times exceeds a predetermined threshold.

According to another aspect of the present invention, there is provided a

method of detecting looping phenomenon, comprising: detecting a checksum value in a frame; counting the number of times a frame having the same checksum value as the detected checksum value is received; and declaring a looping phenomenon when the number of times exceeds a predetermined threshold.

Mode for Invention

The present invention will now be described more fully with reference to the accompanying drawings in which embodiments of the present invention are shown.

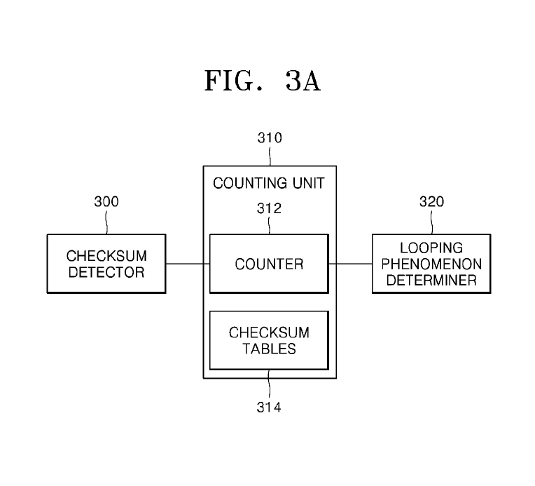

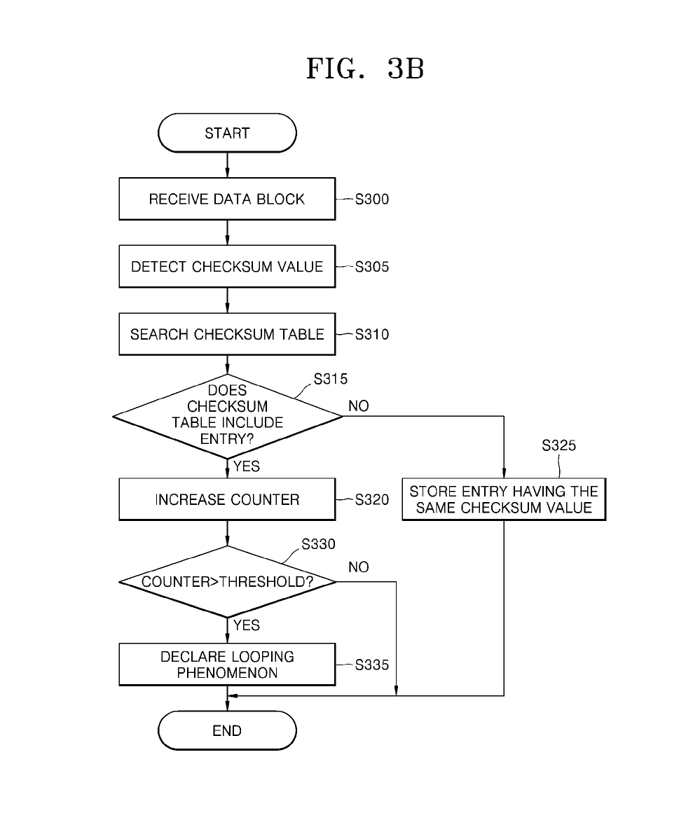

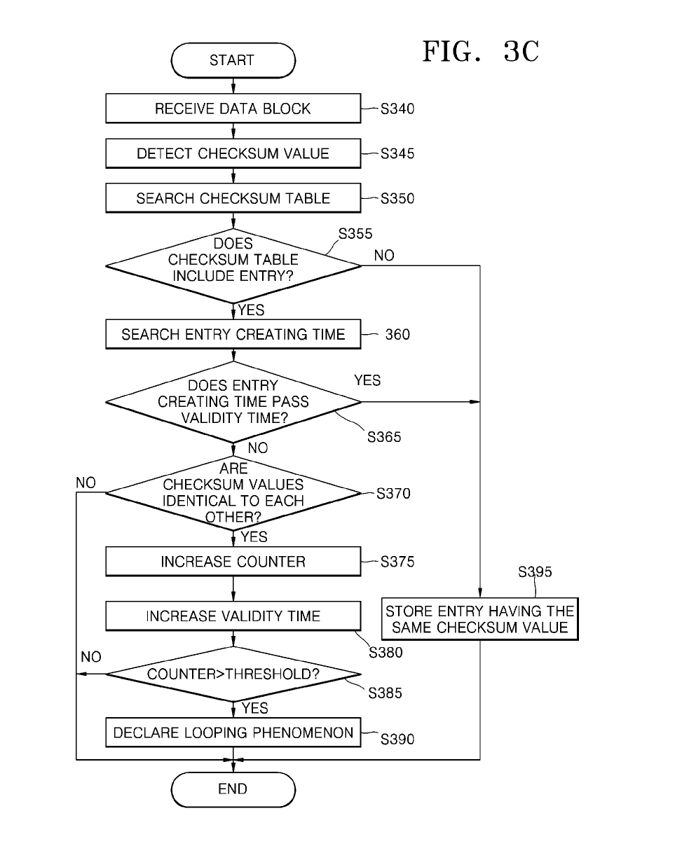

FIG. 3A is a block diagram of a switching device for detecting a looping phenomenon according to an embodiment of the present invention. Referring to FIG. 3A, the switching device for detecting a looping phenomenon comprises a checksum detector 300, a counting unit 310, and a looping phenomenon determiner 320.

The checksum detector 300 detects a checksum value of a frame. In detail, the checksum detector 300 detects a checksum value recorded in a 4-byte frame check sequence (FCS) field of an Ethernet frame.

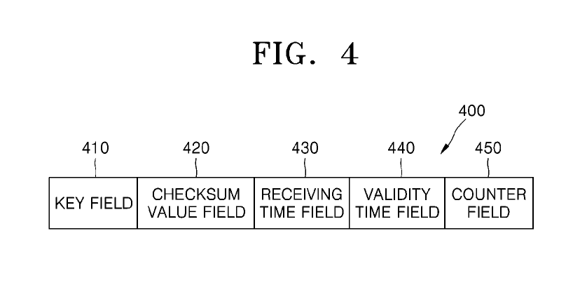

The counting unit 310 stores an entry including the detected checksum value of the frame, a frame receiving time, an entry validity time, and the number (counting unit) of frames received in a predetermined checksum table 314. The checksum table 314 can be realized in various ways depending on the performance and volume of a switching device, and a technology used to embody the switching device. For example, the checksum table 314 may be a hash table, a FIFO queue, etc. A tree list, a hash table, etc. are used to search the checksum table 314. FIG. 4 illustrates the checksum table 314 according to an embodiment of the present invention.

When the counting unit 310 uses the hash table as the checksum table 314, the checksum detector 300 generates a key used to search the hash table using the checksum value.

When an entry including a checksum value of the frame is stored in the checksum table 314, the counting unit 310 checks if the entry validity time passes. When an entry including a checksum value of the frame is not stored in the checksum table 314, the counting unit 310 creates a new entry for the frame, and stores the new entry in the checksum table 314.

When an entry has been stored in the checksum table 314 for longer than the entry validity time, the counting unit 310 removes the entry, creates a new entry for the frame, and stores the new entry in the checksum table 314. The number of the frame for the new entry received by the counting unit 310 is 1. Meanwhile, when the entry has been stored in the checksum table 314 within the entry validity time, the counting unit 310 increases the number (counting unit) 312 of the frame for the new entry received.

When the counting unit 310 counts the number of frames received by the entry, and the number exceeds a predetermined threshold, the looping phenomenon determiner 320 declares a looping phenomenon, and discards the frame in order to correct a route.

Suppose the counting unit 310 uses a hash table to store the checksum value, etc., the counting unit 310 generates a key value from the checksum value and searches the hash table. The hash table stores information on the limited number of frames according to the storage volume of the switching device. When an entry corresponding to the key value has been already used by the different frame in the hash table, a collision occurs in the hash table.

To prevent such a collision, the counting unit 310 restricts a validity time necessary for storing information in each entry of the hash table. The counting unit 310 deletes an entry from the hash table if the entry has been stored longer than the validity time of the entry, the counting unit 310 stores new frame information (a checksum value). If an entry has been in the hash table less than the validity time of the entry, the counting unit 310 discards new frame information. Frame information (the checksum value, the frame receiving time, etc.) is recorded in the hash table during the limited time in order to check for a looping phenomenon of the frame.

If the size of the hash table is small, and the restricted validity time is long, the number of collision may increase. As a result, the number of frames that are dropped because of the collision increases, and this makes it difficult to detect a looped frame. For this reason, the counting unit 310 starts the validity time small number and gradually increases the number whenever a match is found for an entry corresponding to the checksum value.

When the validity time necessary for storing frame information (checksum value, etc.) in the entry of the hash table is restricted to 0.1 seconds and the counting unit 310 does not detect a frame having the same checksum value for 0.1 seconds, the counting unit 310 discards the entry corresponding to the checksum value from the hash table. However, if the counting unit 310 detects a frame having the same checksum value within 0.1 seconds, the frame is highly likely to be a looped frame. In such a situation, the counting unit 310 increases the number of frames received and the entry validity time by 0.1 seconds. Whenever the counting unit 310 searches for the entry corresponding to the checksum value, it increases the number of frames received and the entry validity time. When the number of frames received exceeds the predetermined threshold, the looping phenomenon determiner 320 declares a route looping phenomenon.

The looping phenomenon determiner 320 examines as many frames as possible because the period of time that information of ordinary frames is stored in hash table is short. However, once a frame is detected as potential looping, it checks the frame thoroughly for extended period of time with increasing the validity time. Since a looping frame is repeatedly received by the switching device, any looping frame will have a chance to be stored in hash table and be examined for looping more than once.

FIG. 3B is a flow chart illustrating a method of detecting looping phenomenon using the switching device according to an embodiment of the present invention. Referring to FIG. 3B, the switching device receives a data block from a neighboring node in Operation S300, and detects a checksum value included in the data block in Operation S305. The data block is a frame used for a data communication network, for example, an Ethernet frame or ATM cell frame.

The switching device searches a checksum table in Operation S310. When the checksum table is a hash table, the switching device generates a key value from the checksum value, and searches the hash table using the key value.

The checksum table contains an entry including the checksum value, a data block receiving time, an entry validity time, and the number of data blocks received. The switching device determines whether the checksum table includes an entry corresponding to the checksum value in Operation S315. When the checksum table includes an entry corresponding to the checksum value, the switching device increases the number (counting unit) of data blocks received in Operation S320. When the number exceeds a predetermined threshold in Operation S330, the switching device declares a frame looping phenomenon in Operation S335. When the checksum table does not include an entry corresponding to the checksum value, the switching device creates an entry having the checksum value of the frame and stores the entry in the checksum table in Operation S325.

FIG. 3C is a flow chart illustrating another method of detecting a looping phenomenon using the switching device according to an embodiment of the present invention. Referring to FIG. 3C, the switching device receives a data block from a neighboring node in Operation S340, and detects a checksum value included in the data block in Operation S345. The switching device generates a key value from the checksum value, and searches a checksum table, i.e., a hash table using the key value in Operation S350. The switching device determines whether the checksum table includes an entry corresponding to the key value in Operation S355. When the checksum table does not include an entry corresponding to the key value, the switching device creates an entry having the checksum value of the data block and the data block receiving time, and stores the entry in the checksum table in Operation S395.

When a match of hash key is found in checksum table, the switching device checks if validity time has lapsed as described in Operations S360 and S365. If the validity time has passed, the switching device deletes the entry, creates a new entry for the data block, and stores the new entry in the checksum table in Operation S395. If the validity time has not been lapsed, the switching device checks if the checksum value of the received frame is identical to the stored value in the table in Operation S370.

When a match of checksum is found in Operation S370, the switching device increases a counter and validity time in Operation 375, and in Operation S380. When the counting unit exceeds a predetermined threshold in Operation S385, the switching device declares a looping phenomenon in Operation S390.

FIG. 4 shows format of entry that comprises checksum table used for storing frame information in the switching device according to an embodiment of the present invention. Referring to FIG. 4, the entry consists of a key field 410, a checksum value field 420, a receiving time field 430, a validity time field 440, and a counting unit field 450.

The key field 410 stores a key value used to search each entry of the checksum table 400. When the checksum table 400 is realized as a hash table, the switching device generates a key value from a checksum value of a frame, searches the entry corresponding to the key value.

The checksum value of the frame is stored in the checksum value field 420. When the same checksum value is repeatedly stored in the checksum value field 420, the switching device declares a looping phenomenon.

The receiving time field 430 stores a frame receiving time. The switching device discards an entry if validity time has lapsed from the frame receiving time. The validity time field 440 stores time for the entry stored in the checksum table and valid therein.

The counting unit 450 stores the number of times the same checksum value is repeatedly received. When the number of times the switching device receives the same checksum value exceeds a predetermined threshold during the predetermined time, the switching device declares looping phenomenon.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the present invention is defined not by the detailed description of the invention but by the appended claims, and all differences within the scope of the present invention will be construed as being included in the present invention.

Industrial Applicability

The switching device makes it possible to detect and remove data looping phenomenon without replacing the conventional communication network in a data communication network that does not use a counting unit field, i.e., time to live (TTL), such as an Ethernet network, an ATM network, a frame relay network, etc. The switching device removes a communication interruption, reduces bandwidth consumption, and reduces a congestion phenomenon caused by route looping, thereby improving stability.

1. An apparatus for detecting a looping phenomenon, comprising:
a checksum detector detecting a checksum value in a frame;
a counting unit counting the number of times a frame having the same checksum value as the detected checksum value is received; and
a looping phenomenon determiner declaring a frame looping phenomenon when the number of times exceeds a predetermined threshold.

2. The apparatus of claim 1, wherein the counting unit comprises:
a checksum table storing an entry including a checksum value, an entry validity time, and the number of frames received; and
a counting unit discarding the entry and creating a new entry for the frame after a validity time of an entry having the same checksum value as the detected checksum value has passed, and increasing the number of frames received within the validity time.

3. The apparatus of claim 2, wherein the counting unit increases the validity time as the number of frames received increases.

4. The apparatus of claim 2, wherein the checksum table is a hash table having the checksum value as a key value.

5. The apparatus of claim 1, wherein the frame is an Ethernet frame including the checksum value in a frame check sequence ( FCS) field.

6. The apparatus of claim 1, wherein the looping phenomenon determiner discards the frame when the frame is determined to be a looped frame.

7. A method of detecting looping phenomenon, comprising:
detecting a checksum value in a frame;
counting the number of times a frame having the same checksum value as the detected checksum value is received; and
declaring a looping phenomenon when the number of times exceeds a pre-determined threshold.

8. The method of claim 7, wherein the counting of the number of times comprises:
after a validity time of an entry having the same checksum value as the detected checksum value has passed, discarding the entry and creating a new entry for the frame; and
before the validity time of the entry having the same checksum value as the detected checksum value has passed, increasing the number of the checksum value corresponding to the frame checksum value received.

9. The method of claim 8, wherein the counting of the number of times further comprises:
increasing the validity time of the entry having the same checksum value as the detected checksum value as the number of times of the checksum value corresponding to the frame checksum value received increases.

10. The method of claim 7, wherein the declaring of the looping phenomenon comprises:
discarding the frame when the frame is determined to be a looped frame.
